(19) United States
(12) Patent Application Publication
(10) Pub. No.: US 2015/0221046 A1
(43) Pub. Date: Aug. 6, 2015

(54) System and Method for Managing Referrals Based on a Determination of the Most Appropriate Provider

(71) Applicant: APPLIED RESEARCH WORKS Inc., Palo Alto, CA (US)

(72) Inventors: SHAIBAL ROY, PALO ALTO, CA (US); SUBHENDU AICH, KOLKATA (IN); MADHURIMA DHAR, KOLKATA (IN); KERIANN OSADA, HONOLULU, HI (US); ANANDINI WADERA, San Mateo, CA (US)

(73) Assignee: APPLIED RESEARCH WORKS INC., Palo Alto, CA (US)

(21) Appl. No.: 14/170,812

(22) Filed: Feb. 3, 2014

(51) Int. Cl. G06Q 50/00; G06Q 10/06

(52) U.S. Cl. CPC G06Q 50/00; G06Q 10/06

(57) ABSTRACT

Disclosed is a system and method for determining an appropriate provider for a referral. The disclosed system and method has particular utility in healthcare settings, but also has utility in other sectors. In certain embodiments, the method comprises the steps of obtaining a referral for a patient from a first provider, storing the referral on a central repository, making a determination of an appropriate provider for the referral, and imposing a responsibility to act on the appropriate provider.

### BACKGROUND

In many settings, workflow management presents numerous challenges. Chief among those challenges is assigning work to those carrying out specified tasks, allowing others inside or outside of a given organization to view the work that has been completed or is pending, and providing a means of communication between various users in a given environment. Particularly challenging is facilitating communication and workflow among users in heterogeneous environments.

Such challenges are particularly evident in healthcare settings. In healthcare settings, referrals are made between numerous providers. For example, primary care physicians often refer patients to specialist physicians. Additionally, physicians often order tasks to be completed by other providers such as imaging studies, laboratory studies. Complicating workflow management in the healthcare setting is the existence of heterogeneous network environments that use different computer systems and software. Physicians often refer patients to specialists and other providers in different organizations, with each organization using its own procedures and electronic systems for record management and communication. Additionally, payers, such as health plans and government sources, often authorize payment for certain procedures and may limit the providers that may be available to a given patient.

To properly manage workflow in the healthcare setting, across multiple environments, a number of methods may be implemented to improve the workflow management process. First, a means to refer a patient to a given provider, and impose a responsibility on the provider to act upon the referral provides a clear assignment of a task related to clinical care and ensures a patient's needs will be adequately addressed. Additionally, when a responsibility to act is imposed on a provider, there is a single individual responsible for following up on the care of a patient.

Second, a method to determine the most appropriate provider for a referral ensures a provider to whom a patient has been referred is an appropriate provider for the patient. For example, a patient with a given disease would benefit from treatment from a physician with advanced training in management of the patient's disease, while the patient would derive no benefit from a referral to a physician who has limited experience with a given disease. Further, some physicians may not accept a given patient's insurance or may be outside a geographic scope in which the patient wishes to travel. By ensuring a patient is referred to appropriate physician, the patient will be treated by a physician who will not have to refer the patient to another provider and the physician will be able to use his time to focus on patients he is able to treat.

Third, by allowing physicians to specify certain rules of engagement for patient referrals, the physician is able to ensure referrals the physician receives will be patients of the type the physician is willing and able to treat.

Finally, a user interface that presents all relevant information in a clear, easy to use manner can facilitate workflow by allowing physicians to quickly see incoming referrals and make outbound referrals to other providers.

Although healthcare has needs for workflow management, other industries have similar needs to manage workflow and referrals. Therefore, the solutions discussed above may be used to address challenges in numerous industries and sectors where workflow management and management of referrals currently present challenges.

### BRIEF SUMMARY

Disclosed is a system and method managing workflow in a healthcare setting. Certain embodiments have utility in managing workflow in other applications such as information technology management, financial management, and other applications.

Disclosed is a system wherein information is shared between users, accessing data stored on a shared repository through devices coupled to the internet or other networks. A method to determine the most appropriate physician to who a patient should be referred is also disclosed. This determination is made using criteria including a patient's clinical information, a patient's geographic proximity to the provider, a provider's ability to provide adequate care to a patient based on the provider's experience, and a patient's insurance information.

Also disclosed is a method for handling and processing referrals though the imposition of responsibilities to act upon physicians receiving referrals. Responsibilities to act are imposed when a physician receives a referral from another physician. Responsibilities to act are removed when a physician acts upon the referral.

Further, a method of using rules of engagement to process patient referrals to physicians is disclosed. In this embodiment, physicians are able to establish their own rules of engagement wherein the system will determine whether a referral should be made to a given physician. In an alternative embodiment, rules of engagement can be predetermined based on factors such as a physician's specialty.

Finally, a user interface is disclosed wherein physicians can receive referrals from other physicians, make referrals to other physicians, and act upon referrals received. Additionally, the user interface allows physicians to access patient information and transmit and receive messages among other physicians.

### BRIEF DESCRIPTION OF THE DRAWINGS

FIG. 1 illustrates an embodiment of a system, including serves and networks coupled to one or more central repositories.

FIG. 2 illustrates an embodiment of a method to determine an appropriate referral.

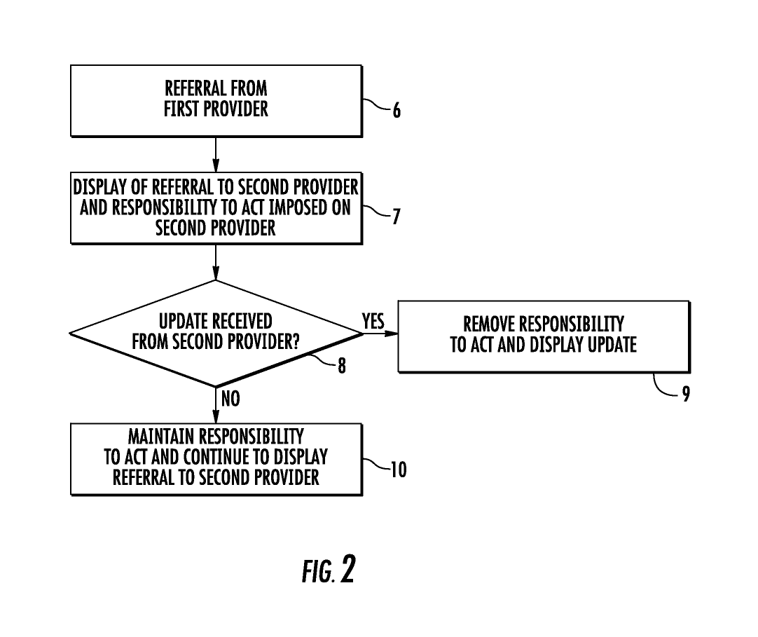

FIG. 3 illustrates an embodiment of a method for processing referrals.

FIG. 4 illustrates an embodiment of a method of processing referrals based on rules of engagement.

FIG. 5 illustrates an embodiment a user interface wherein a physician can refer a patient to other providers and request information from other providers.

FIG. 6 illustrates an embodiment of a user interface wherein a “query/respond” function is displayed.

FIG. 7 illustrates an embodiment of a user interface wherein a physician can use the “query/respond”function to transmit messages to another provider.

FIG. 8 illustrates an embodiment of a user interface wherein a status indicator is visible.

FIG. 9 illustrates an embodiment of a user interface wherein a physician's workflow is displayed with status indicators.

FIG. 10 illustrates an embodiment of a user interface illustrating status indicators appearing as solid status indicators or hollow status indicators.

FIG. 11 illustrates an embodiment of a user interface where in the “query/respond” function is used to respond for a request for information.

FIG. 12 illustrates an embodiment of a user interface wherein the “query/respond” function is used to send a message to a referring physician.

FIG. 13 illustrates an embodiment of a user interface wherein the status indicator has been removed from a given task.

FIG. 14 illustrates an embodiment of a user interface wherein a solid dot status indicator appears on a referring physician's workflow to indicate an inbound communication.

FIG. 15 illustrates an embodiment of a user interface wherein updates on a given patient are presented to a physician in response to actions taken by other providers.

FIG. 16 illustrates an embodiment of a user interface wherein the “query/respond” function is used to indicate a given task is complete.

FIG. 17 illustrates an embodiment of a user interface wherein a status indicator is removed to indicate the completion of a task.

### DETAILED DESCRIPTION

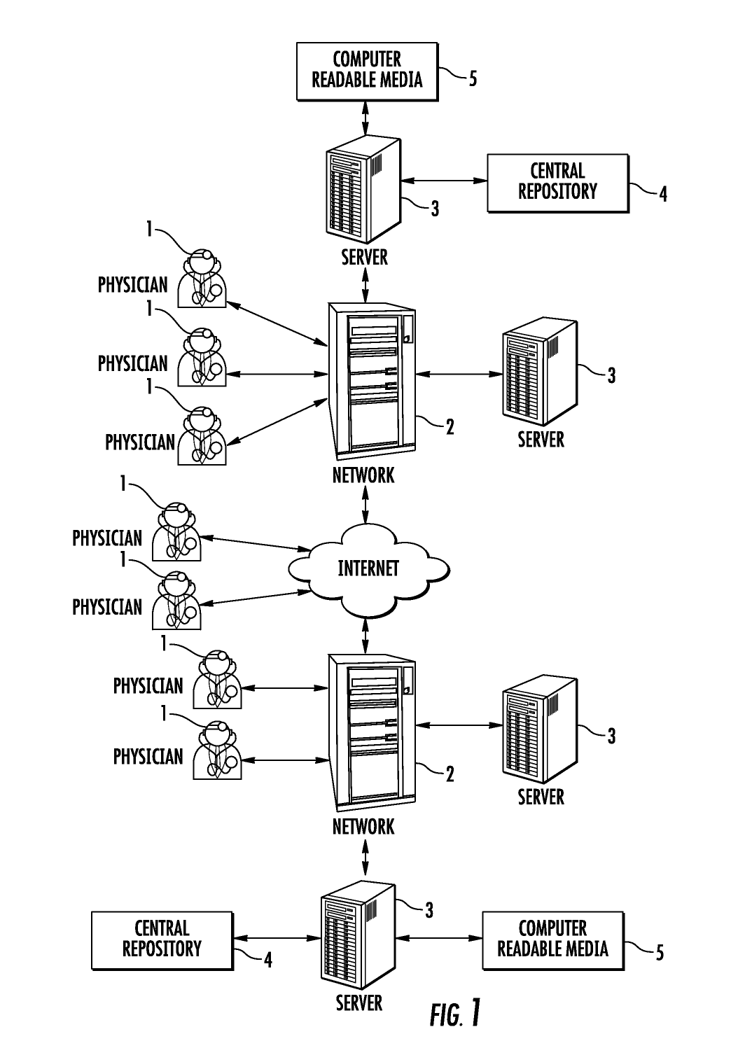

Disclosed is a system and method for managing workflow among users of an electronic service wherein the service is used for the storage, retrieval, and transmission of information in a healthcare setting. FIG. 1 illustrates a representative embodiment of the disclosed system. In certain embodiments, physicians 1 are users who share information over one or more internet based applications. Alternative embodiments comprise one or networks 2, which may be optionally coupled to the Internet. The system comprises one or more servers 3, each server 3 coupled to one or more networks 2. In certain embodiments, one or more servers 3 are coupled to the Internet. In certain embodiments, non-transitory computer readable media 5 encoding instructions for carrying out various methods is coupled to one or more servers 3. Users connect to the system servers through various devices having connections to one or more networks 2, or the Internet. In alternative embodiments, users may access the system through local area networks, telephonic devices, radio frequencies, computers, or other electronic devices. In certain embodiments, data obtained through, and transmitted over the system resides on one or more central repositories 4. The one or more central repositories 4 may be associated with thin or thick clients where data transmitted through the system will be synchronized. In certain embodiments, all data transmitted and displayed to users resides on the central repository 4.

In certain embodiments, the users of the system will be physicians 1. Alternatively, delegates of physicians, allied healthcare workers, payers, patients, and non-healthcare professionals may also be users of the system. The terms “physician”, “provider”, and “user”, as used herein, may be used interchangeably to refer to a user of the system.

When a referral is made by a first provider 6 to a second provider, a status is assigned to the second provider indicating a responsibility to act 7. The system then determines if an update has been received from the second provider 8. If an update has not been received from the second provider, a responsibility to act is imposed on the second provider and the responsibility to act is displayed to the second provider 10. If an update is received from the second provider 8, the responsibility to act is removed and a status indicator is no longer displayed to the second physician and an update is displayed to the first physician 9. In certain embodiments, the responsibility to act is displayed on a user interface as a solid dot. In certain embodiments, the status indicator is visible to multiple users of the system. Additionally, in certain embodiments, a responsibility to act can be imposed on a second physician for tasks other than referrals such as providing information to the first physician, scheduling an appointment with a patient, uploading a document, or completing another task specified by the system.

When a second provider has a responsibility to act imposed, the second provider may select a response indicating what action the second provider has taken in response to the responsibility to act. By way of example, and not limitation, the following are options a second provider may select after a responsibility to act has been imposed:
1. “Save and Continue”. The second provider may update the central repository by scheduling an appointment with a patient. Here, status does not change. The second provider still has a responsibility to act imposed, but an appointment is scheduled with a patient. A scheduled appointment may be visible to the first physician in certain embodiments.
2. “Save and Completed”. The second provider may change the taking a certain action. For example, a second provider may input results of a diagnostic study, treatment notes, or other data to indicate a patient has been seen or treated by the second provider. Alternatively, the second provider may prescribe medication to a patient, schedule or perform a procedure, order a diagnostic study, or request a consultation with a third physician. Once such an action is taken, the responsibility to act is removed from the second provider, as the duty to act has been completed.
3. “Save and Assign”. The second provider may decide to forward this assignment to a third provider. In this instance, the responsibility to act is removed from the second provider and imposed on the third provider. This results in a referral to the third provider.

When a given responsibility to act has been addressed, the status indicator displayed on the user interface will change to reflect the completion of a responsibility to act. In embodiments where a solid dot or hollow dot is used to indicate a responsibility to act on a second provider, a solid dot or hollow dot will no longer be displayed to the second provider when a responsibility to act had been completed.

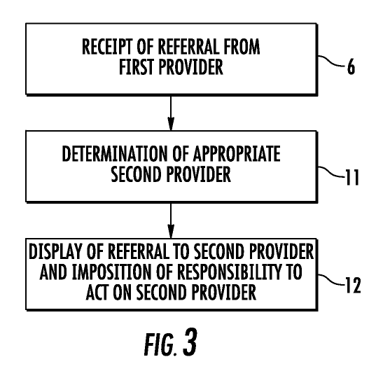

FIG. 3 illustrates a basic embodiment of a method to determine the most appropriate second provider. When a referral is obtained from a first provider 6, the system will determine one or more appropriate second providers to whom a patient can be referred 11. Once the system has determined an appropriate second provider, a referral is made and a responsibility to act is imposed on the second provider who was determined to be the most appropriate second provider. In certain embodiments, the determination of an appropriate second provider is made based on rules of engagement set forth by one or more second providers.

In certain embodiments, appropriate second providers are determined using predetermined criteria. Such criteria may include associating a patient's diagnosis with a disease commonly treated by a second provider's specialty or area of practice. In addition, certain embodiments may also include factors such as patient address to match a patient with a provider in close proximity to the second provider. Other factors that can be utilized can be based on the first physician's relationship with a second physician. In this instance, a second physician may have a working relationship with a first physician. If one or both physicians inputs this information into the system, the system may determine a second physician as being the most appropriate physician for a referral on the basis of the second physician's relationship with the first physician. Additionally, a determination of an appropriate second physician for referral can be based on financial considerations. For example, if a second physician accepts a patient's insurance or is a preferred provider on the patient's health plan, the second provider would be considered an appropriate for a referral. Additional criteria for determining an appropriate second physician also includes a physician's skill in a given procedure or familiarity with a given diagnosis. For example, a physician know to have considerable experience with a given disease would be considered an appropriate second physician for patients diagnosed with that disease. A physician skilled in a given procedure would be considered an appropriate second physician for patients being referred for that procedure. In certain embodiments, the system is able to aggregate data and determine the exact number of patients each physician has seen or treated with a given diagnosis or to undergo a given procedure. Thus, the system is able to make a determination as to a physician's familiarity with a given diagnosis or skill in a given procedure based on numbers of patients who have presented to each physician with a given diagnosis or to undergo a given procedure. In certain embodiments, such data is aggregated from insurance claims data. For purposes of determining an appropriate second provider, the criteria listed above may be used individually or in combination with any or all of the criteria included herein.

In certain embodiments, rules of engagement may be set forth by physicians. Rules of engagement may be set forth by a physician reside on the central repository. In certain embodiments, a physician may enter certain rules of engagement into the central repository. In certain embodiments, a specialized user interface is used by the physician to enter his rules of engagement. On the basis of these rules or engagement, the system may suggest a list of second physicians to whom a first physician may refer a patient. The list of second physicians may be displayed in the order of best possible match for a given context. In so doing, a patient may be referred to a second physician having the appropriate level of skill and experience to treat a given condition. In certain embodiments, the rules of engagement are used to generate a list of second providers for informational purposes only and the system does not impose any restriction on referral activity based on a physician's rules of engagement.

Certain embodiments may set forth templates of rules of engagement for second physicians. Templates for rules of engagement may be displayed by a user interface wherein the second physician will approve or modify suggested rules of engagement. Certain embodiments will provide rules of engagement to second physicians that are obtained from recognized organizations that establish accepted standards of care and treatment. For example, rules of engagement for an oncologist may be based on guidelines set forth by the National Cancer Care Network (NCCN). Certain embodiments may set a second physician's default rules of engagement based on the second physician's specialty. In other embodiments, a second physician's default rules of engagement may be based on diagnostic codes and procedure codes pertinent to the second physician's specialty and area of practice.

An example of a use of rules of engagement is the use of rules of engagement by a second physician having a narrow specialty. In this instance, a second physician may set forth rules of engagement that will only allow patients satisfying certain criteria. For example, a gastroenterologist may set forth rules of engagement limiting patient referrals to patients having a diagnosis of gastrointestinal disease. Similarly, a second physician may also narrow patient referrals by age, type of insurance, location of the patient, specific diagnosis, order for a specific procedure, or other criteria available to the system.

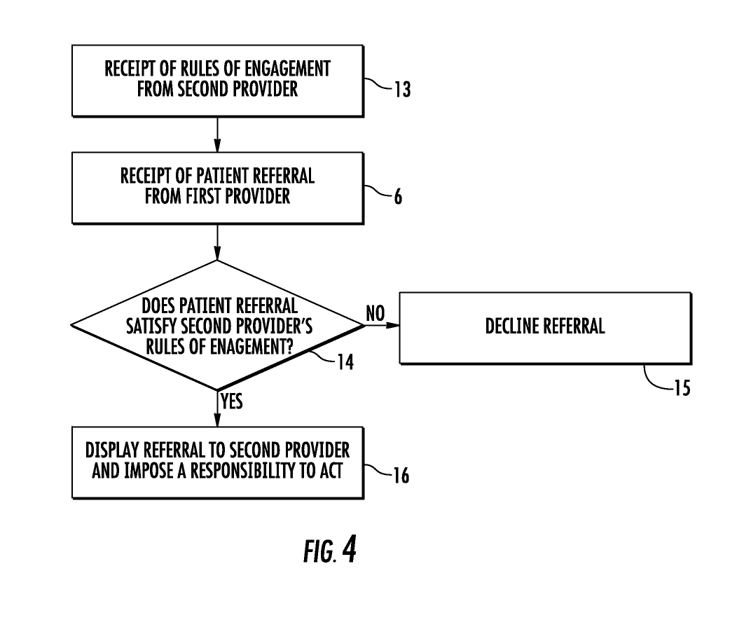

Although certain embodiments use rules of engagement only for informational purposes to first physicians, in other embodiments, rules of engagement can be used to restrict referrals that will be made to a second physician. Such an embodiment is illustrated in FIG. 4. In such instances, the system will not allow a patient to be referred to a second physician if the patient does not satisfy the second physician's rules of engagement. In this instance, it will not be possible for a responsibility to act to be imposed on a second physician to treat or examine a patient who does not satisfy the second physician's rules of engagement.

In certain embodiments, the system has the ability to determine to whom a patient should be referred without additional information. For example, if a patient is seeking a referral to a second physician who is a specialist, and the first physician, who is the referring physician, is a primary care physician who has not treated the patient before, the system will not allow a referral to be made to the second physician. In such embodiments, the system will impose a responsibility to act on the first physician. The first physician may then complete the responsibility to act by treating the patient or referring the patient to a second physician.

In another embodiment, a second physician can set forth rules of engagement employing multiple levels of rules of engagement. For example, a second physician may establish primary rules of engagement and secondary rules of engagement. In this instance, a given patient must first satisfy the criteria set forth in the primary rules of engagement. If the patient does not satisfy the primary rules of engagement, a referral will not be made to the second physician. If the patient satisfies the primary rules of engagement, the system will then assess whether the patient satisfies the secondary rules of engagement. If the patient does not satisfy the secondary rules of engagement, no referral is made to the second physician. In an embodiment where the second physician has only primary rules of engagement and secondary rules of engagement, a referral is made if the patient who satisfies the criteria set forth in the primary rules of engagement also satisfies the criteria set forth in the secondary rules of engagement. In certain embodiments, the physician may establish an infinite number of levels of rules of engagement.

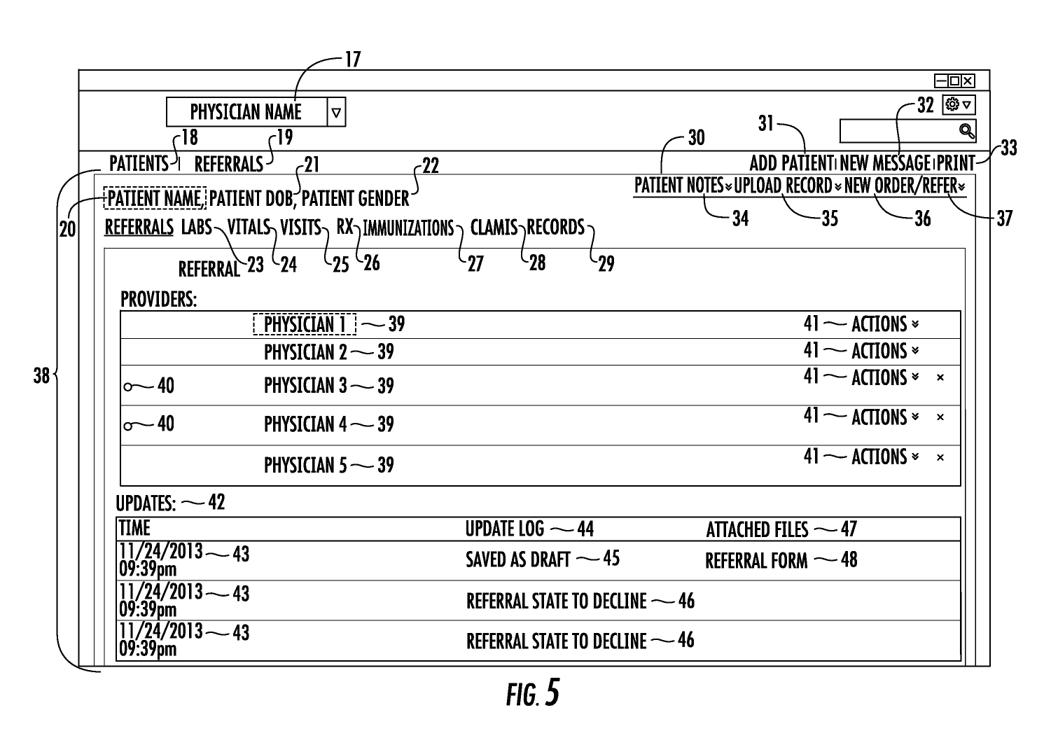

In many embodiments, information from the central repository 4 is displayed to physicians, and manipulated by physicians thought a user interface. Various aspects of embodiments of a user interface are illustrated in FIGS. 5-17. Referring to FIG. 5, a user interface, accessed with a web browser is depicted. The user interface shows the first physician's name 17. Physicians are able to navigate and access various information by clicking the information displayed on the user interface. Information that can be accessed from the user interface includes a physician's patients 18 and a physician's referrals 19. Optionally, the physician may add a patient 31, create a new message 32, or print information displayed in the user interface. When a given patient is selected in the user interface, the patient name 20, patient date of birth and patient gender 22 is displayed. A physician has the ability to add patient notes 34, upload a record 35, create a new order 36, and refer a patient 37. Additionally, certain embodiments allow the physician to access patient laboratory data 23, vital signs 24, visits 25, prescriptions 26, immunizations 27, insurance claims 28, and records 29. Referral activity is displayed in a referral box 38. Data included in the referral box relates to other physicians and providers to whom the patient has been referred and the reasons for, and outcomes of those referrals. The name of the physician 39 who made the referral, or to whom a referral is made, is displayed. Next to certain referrals in the referral box 38, a hollow status indicator 40 is shown. An action icon 31 can be clicked by the physician to act upon the referral displayed. Additional information appearing in the referral box 38 includes one or more updates 42 and dates and times of the updates 43. FIG. 5 illustrates possible update statuses for each update including “saved as draft” 45 and “referral state to decline” 46. Attached files 47 may also be displayed. An example illustrated in FIG. 5 is a referral form 48.

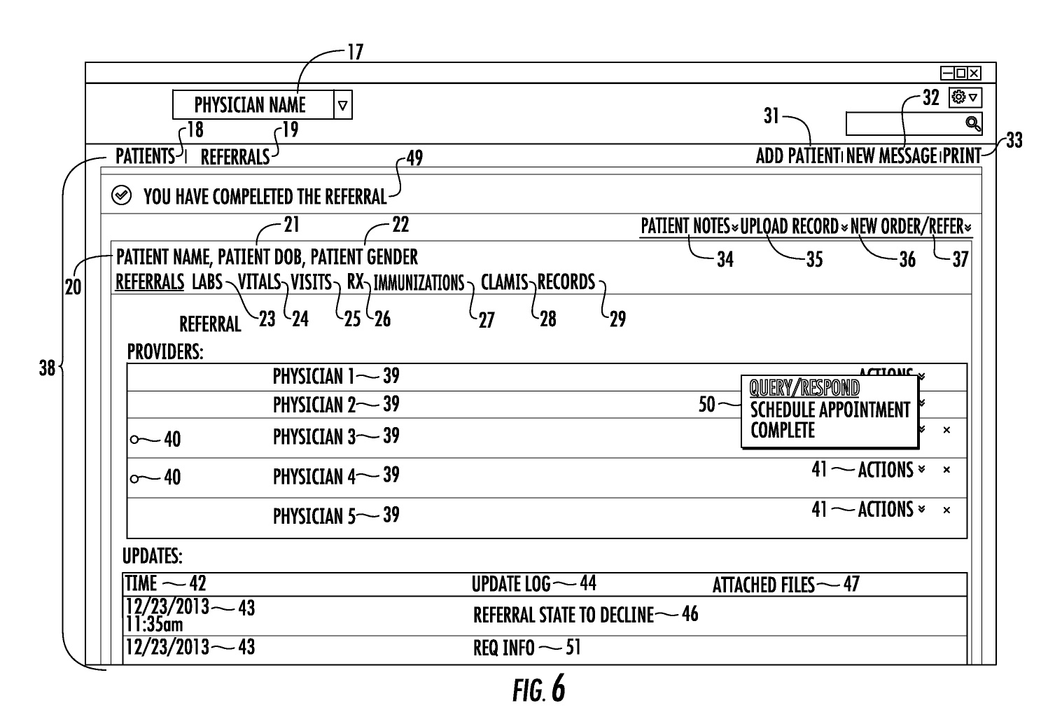

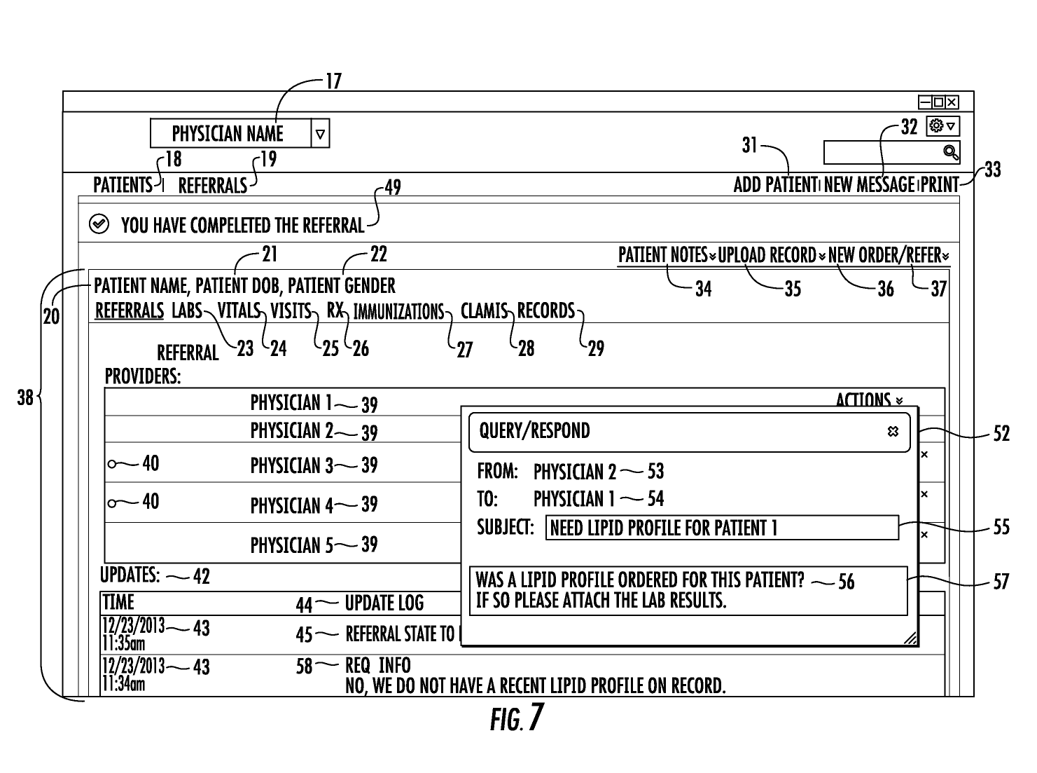

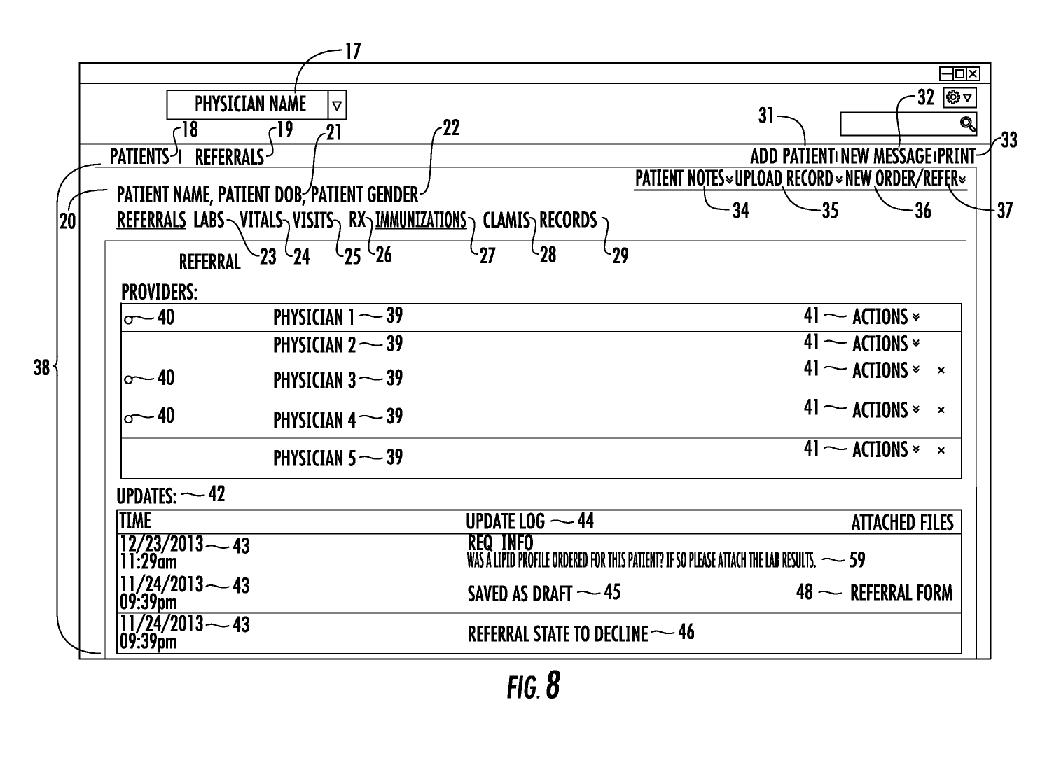

When a physician wishes to take action on a given referral, a physician can click on the action icon 41. FIG. 6 illustrates a query/respond box 50 that appears when a physician clicks the action icon 41. The physician may select the options contained within the query/respond box 50, which may include various options. FIG. 7 illustrates a secure message box 52 that may appear when a physician elects to transmit a message to another physician. In the example illustrated, physician 1 54 is a physician who referred the patient to physician 2 53. In the example illustrated by FIG. 7, Physician 2 53 is transmitting a message 56 to physician 1 54. In certain embodiments, such messages 56 transmitted may include a subject line 55. FIG. 8 illustrates a hollow status indicator 40 next to the name of physician 1 39, after a message has been transmitted to physician 1 39.

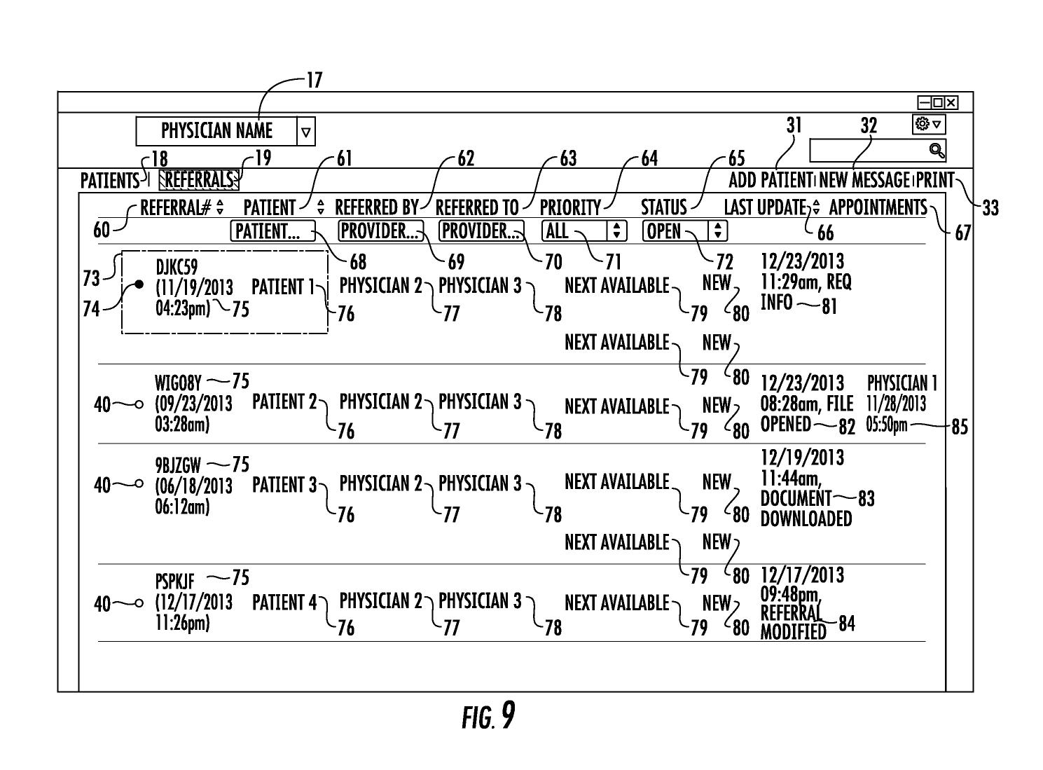

FIG. 9 illustrates an embodiment of a display of a physician's 17 existing referrals 19 and responsibilities to act. Displayed, are referrals 60, with each referral 73, having an individual referral number 75. Information associated with each referral is displayed including patient 61, the referring physician 62, the physician to whom a given patient was referred 63, a priority 64, a status 65, the date and time of the last update 66, and appointments 67. Also displayed are hollow status indicators 40 and a solid status indicator 74. In this illustration, the solid status indicator 40 is displayed to indicate a new message 56 that pertains to a specific patient 76.

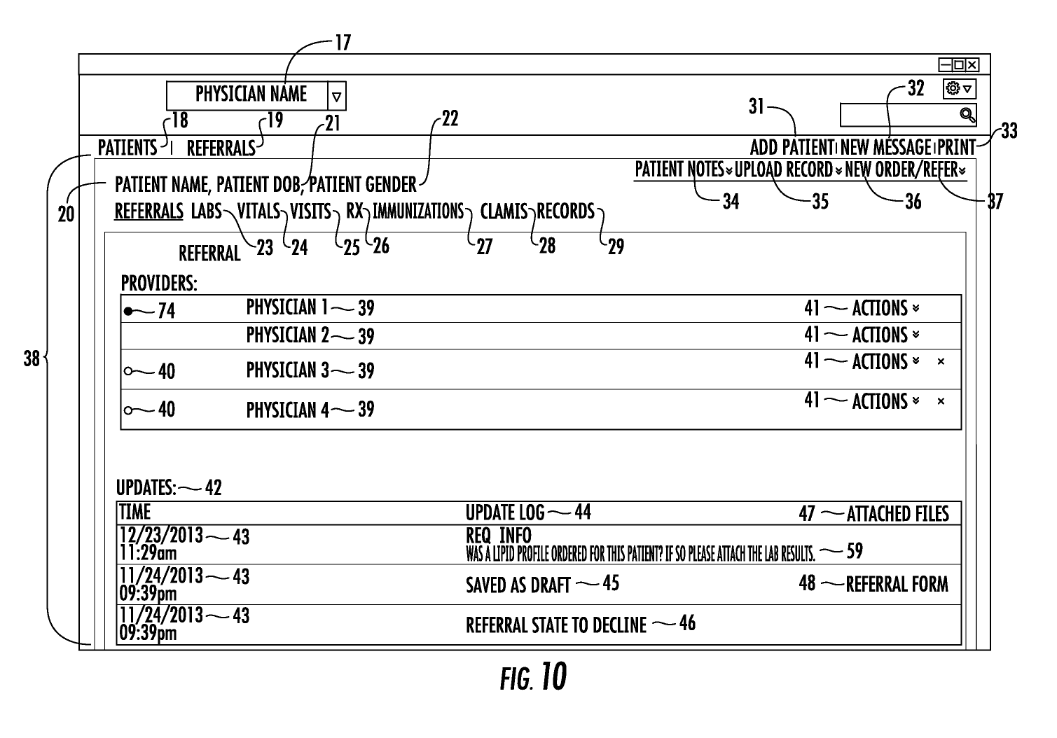

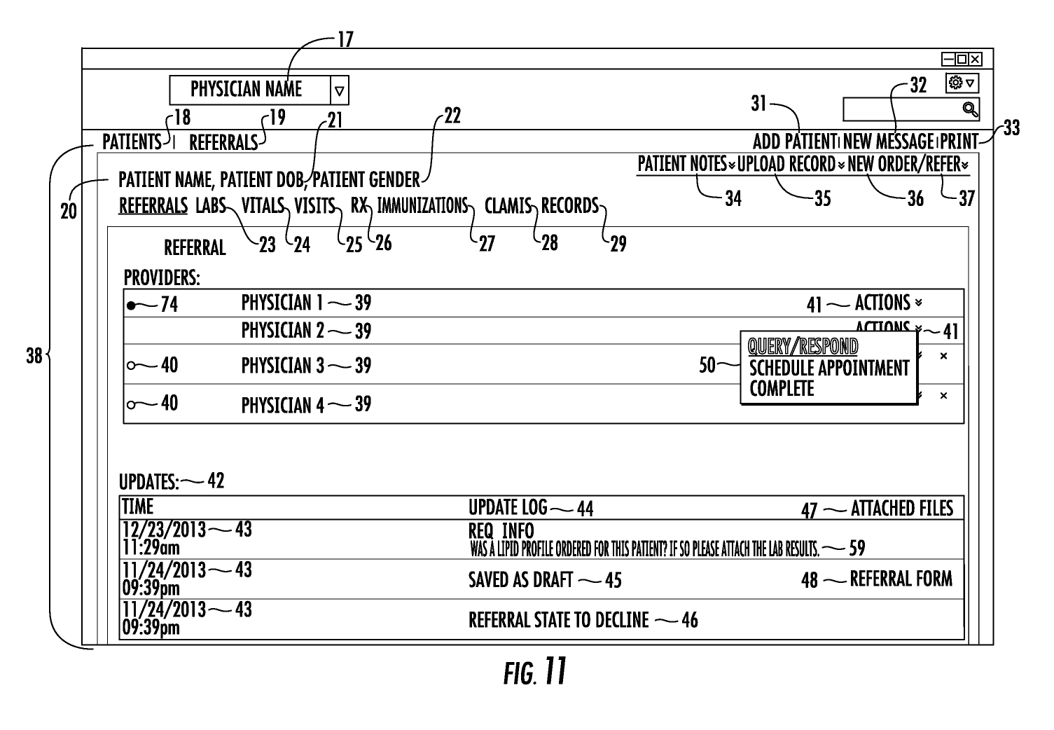

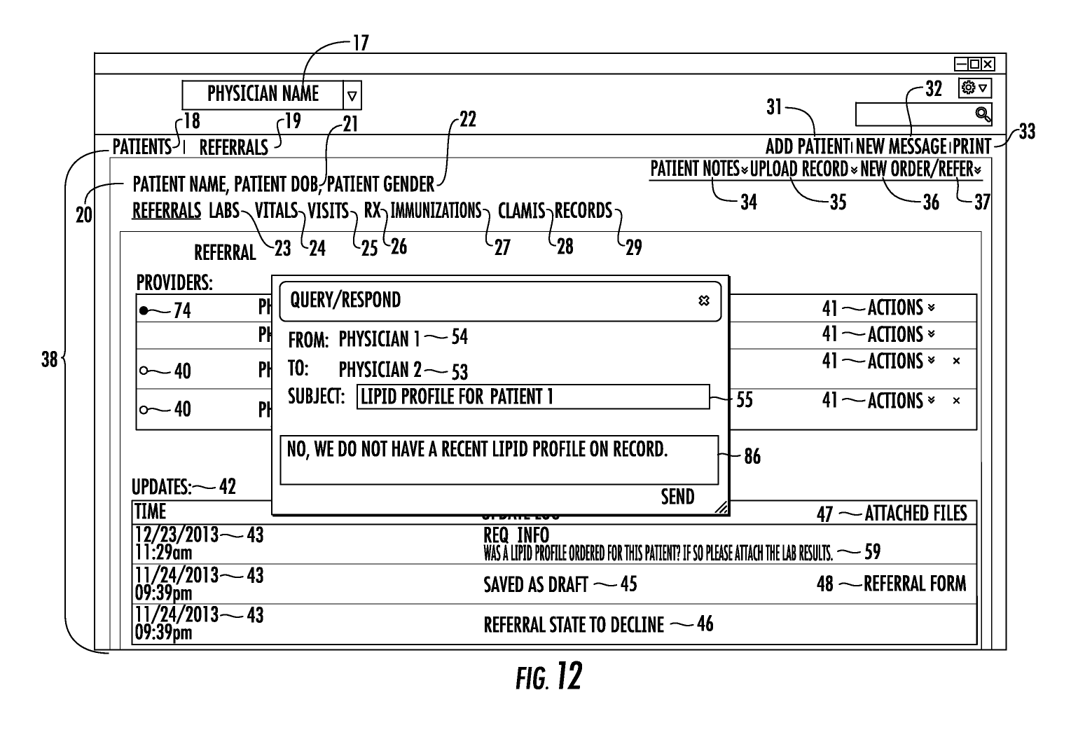

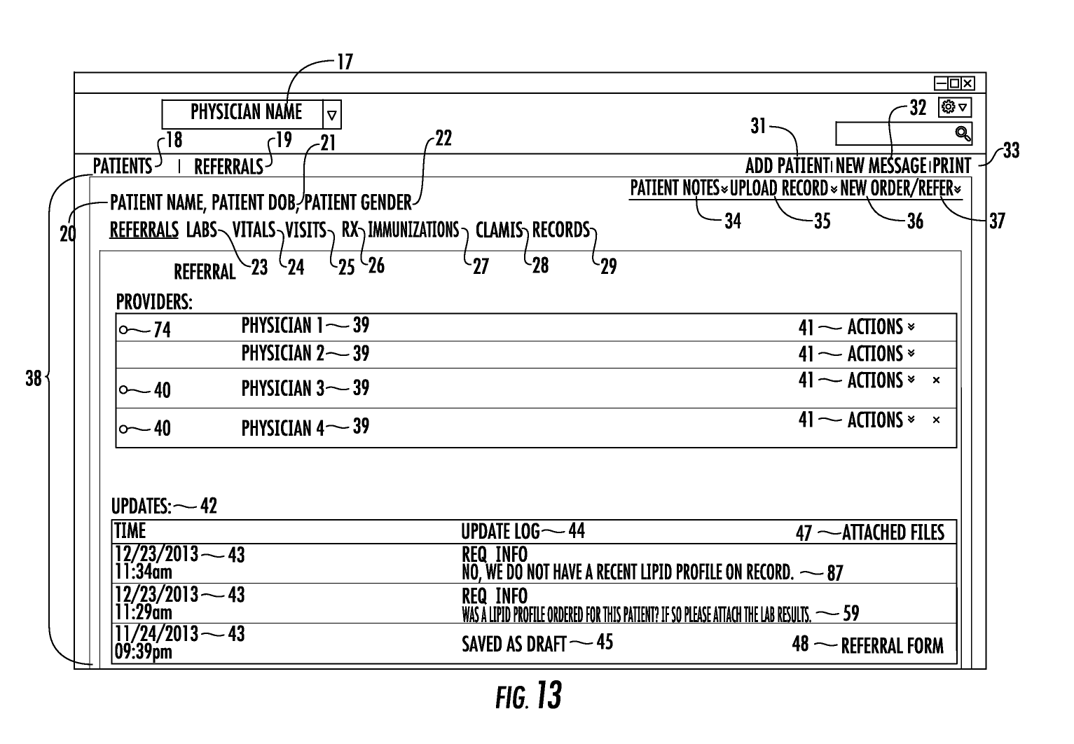

FIG. 10 illustrates an update 42 and the text of the message 56 as a request for information 59 in the update log 44 in the referral box 38. FIG. 11 illustrates a query/respond box 50 appearing when the physician wishes to act upon request for information 59 appearing in the update log 44. The query/respond box 50 appears when the physician clicks on the action icon 41. FIG. 12 illustrates a secure message box 82 wherein physician 1 54 transmits a message 86 to physician 2 53. FIG. 13 illustrates the disappearance of the solid status indicator 74 and the inclusion of the of the text from the message 86 sent in response to the request for information 87, appearing in the update log 44, in response to physician 1 54 transmitting a message 86 to physician 2 53.

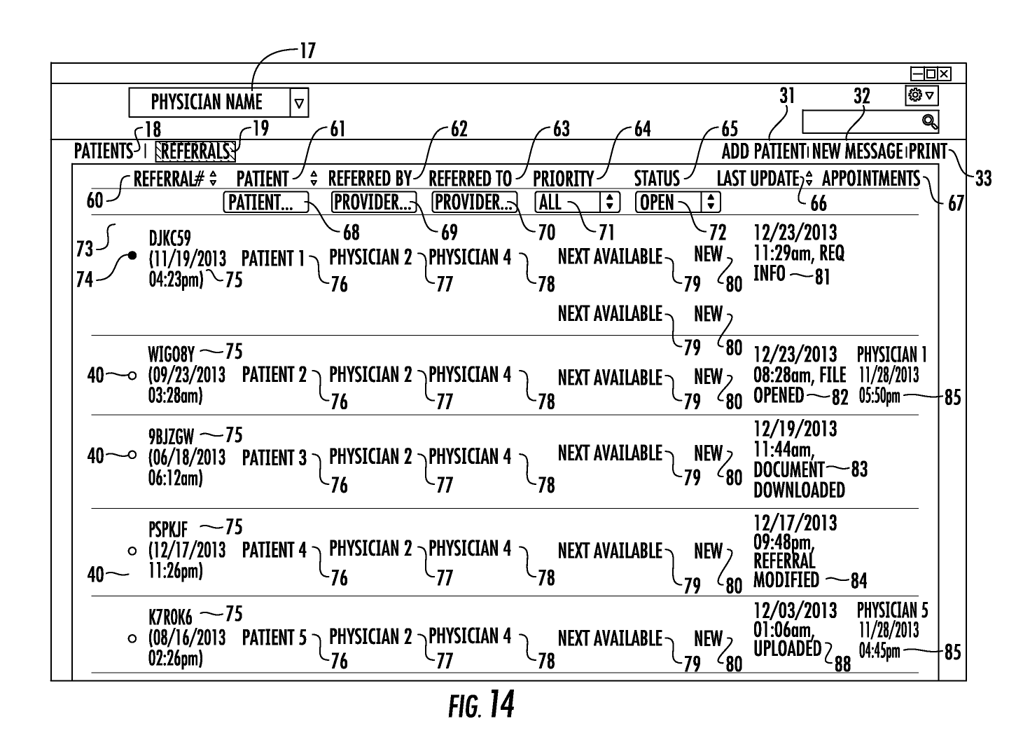

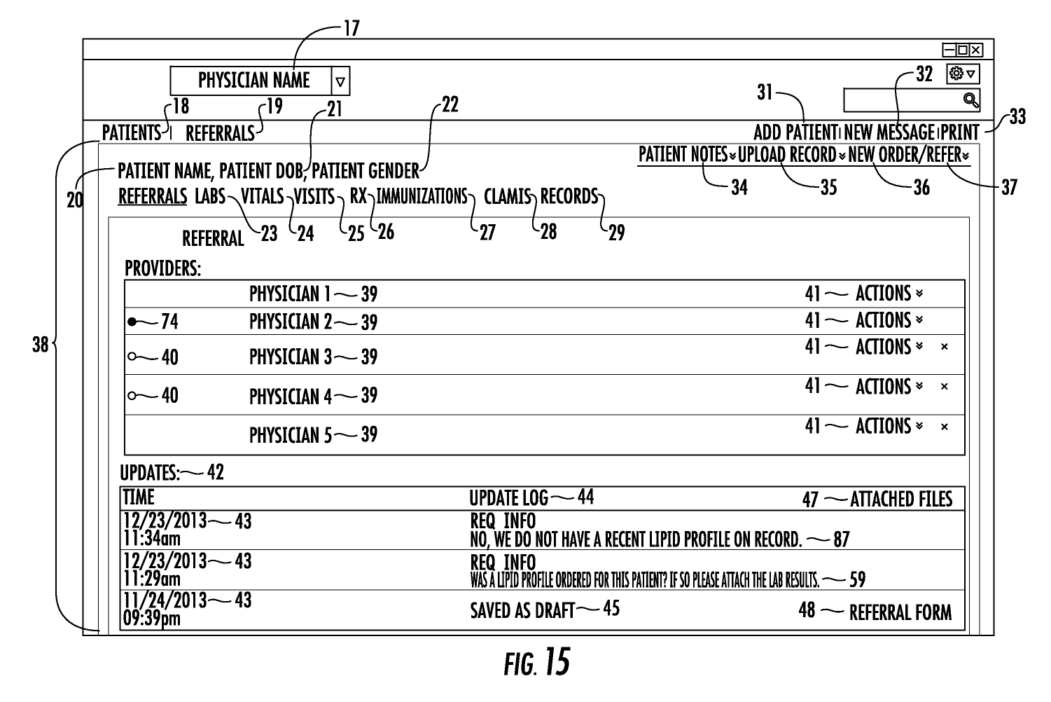

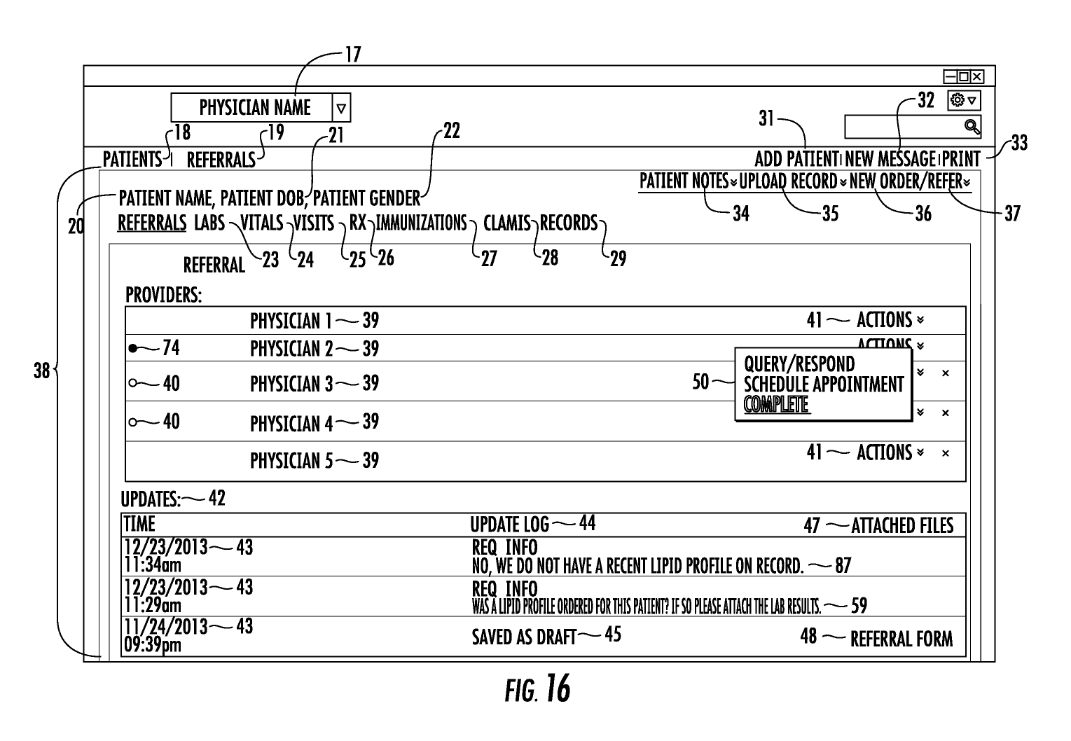

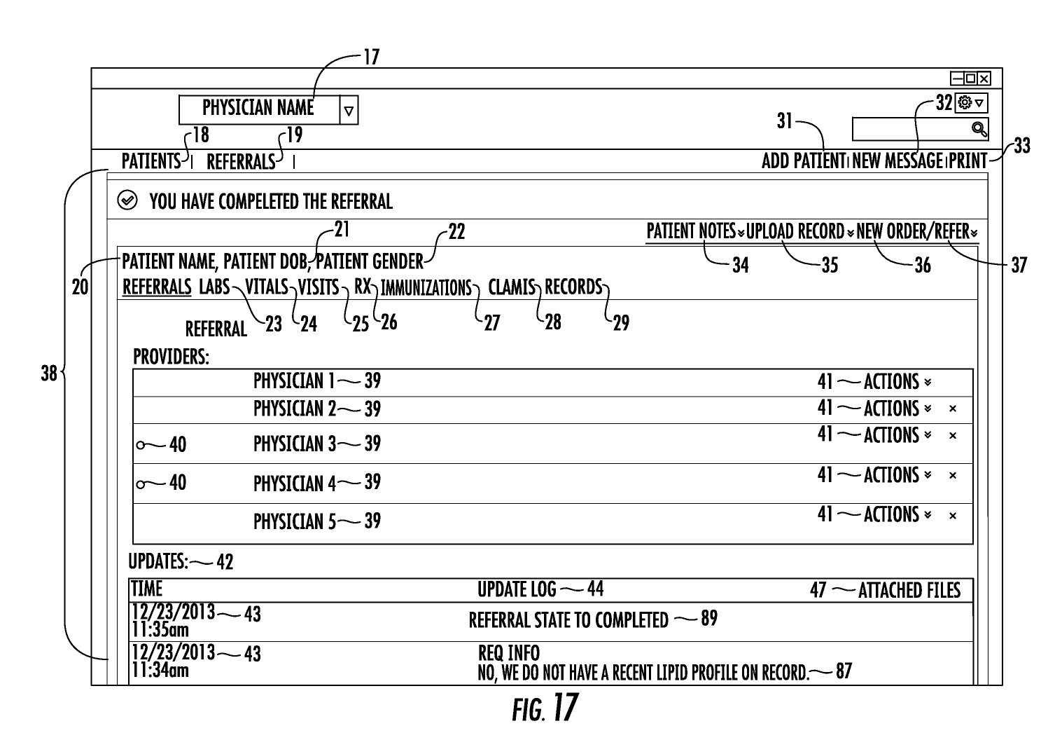

FIG. 14 illustrates the appearance of a solid status indicator 74 to indicate a message had been transmitted in response to the physician 17. FIG. 15 illustrates the update log 44 indicating the initial request for information 59 and the response to the request for information 87. FIG. 16 illustrates a query/respond box 50 wherein a physician can indicate a given task is complete. FIG. 17 illustrates the disappearance of the solid status indicator 74 after the physician 17 indicates the status is complete through the query/respond box 50.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. In particular, those skilled in the art will appreciate that the present invention has utility in multiple settings and industries. Although healthcare applications were disclosed in detail, the application of the present invention is not limited to healthcare. It is intended, therefore, that the invention be defined by the scope of the claims that follow and that such claims be interpreted as broadly as reasonable.

What is claimed is:

1. A computerized method for determining an appropriate provider comprising the steps of:
obtaining a referral for a patient from a first provider through a computer system, wherein the system comprises one or more networks;
storing the referral on a central repository, wherein the central repository receives and stores data transmitted through the system;
making a determination of an appropriate provider for the referral;
imposing a responsibility to act on the appropriate provider; and
displaying a status indicator to the appropriate provider through a user interface.

2. The method for determining an appropriate provider of claim 1 wherein the determination of the appropriate provider is based on the patient's diagnosis.

3. The method for determining an appropriate provider of claim 1 wherein the determination of the appropriate provider is based on the patient's address.

4. The method for determining an appropriate provider of claim 1 wherein the determination of the appropriate provider is based on a working relationship the first provider has with a second provider.

5. The method for determining an appropriate provider of claim 1 wherein the determination of the appropriate provider is based on the patient's insurance.

6. The method for determining an appropriate provider of claim 1 wherein the determination of the appropriate provider is limited to providers who are preferred provider on the patient's health plan.

7. The method for determining an appropriate provider of claim 1 further comprising the steps of:
aggregating insurance claims data;
determining a level of skill of a provider based on the insurance claims data; and
making the determination of the appropriate provider for the referral based on the level of skill of the provider based on the insurance claims data.

8. The method for determining an appropriate provider of claim 1 further comprising the step of displaying the responsibility to act to the appropriate provider through a user interface.

9. A non-transitory computer-readable medium having computer-executable instructions for determining an appropriate provider comprising the steps of:
obtaining a referral for a patient from a first provider through a computer system, wherein the system comprises one or more networks;
storing the referral on a central repository, wherein the central repository receives and stores data transmitted through the system;
making a determination of an appropriate provider for the referral;
imposing a responsibility to act on the appropriate provider; and
displaying a status indicator to the appropriate provider through a user interface.

10. The non-transitory computer-readable medium having computer-executable instructions for determining an appropriate provider of claim 9, wherein the wherein the determination of the appropriate provider is based on the patient's diagnosis.

11. The non-transitory computer-readable medium having computer-executable instructions for determining an appropriate provider of claim 9, wherein the wherein the determination of the appropriate provider is based on the patient's address.

12. The non-transitory computer-readable medium having computer-executable instructions for determining an appropriate provider of claim 9, wherein the determination of the appropriate provider is based on a working relationship the first provider has with a second provider.

13. The non-transitory computer-readable medium having computer-executable instructions for determining an appropriate provider of claim 9, wherein the determination of the appropriate provider is based on the patient's insurance.

14. The non-transitory computer-readable medium having computer-executable instructions for determining an appropriate provider of claim 9, wherein the determination of the appropriate provider is limited to providers who are preferred provider on the patient's health plan.

15. The non-transitory computer-readable medium having computer-executable instructions for determining an appropriate provider of claim 9, wherein the computer-executable instructions for determining an appropriate provider further comprise the steps of:
aggregating insurance claims data;
determining a level of skill of a provider based on the insurance claims data; and
making the determination of the appropriate provider for the referral based on the level of skill of the provider based on the insurance claims data.

16. The non-transitory computer-readable medium having computer-executable instructions for determining an appropriate provider of claim 9, wherein the responsibility to act is displayed to the appropriate provider through a user interface.
